(19) United States
(12) Patent Application Publication
(10) Pub. No.: US 2009/0087293 A1
(43) Pub. Date: Apr. 2, 2009

(54) Apparatus and a system for lifting and storing an article and a method for using the same

(76) Inventors: Craig A. Earsley, Nekoosa, WI (US); Susan E. Earsley, Nekoosa, WI (US)

Correspondence Address: PATENTS+TMS, P.C., 2849 W. ARMITAGE AVE., CHICAGO, IL, 60647, US

(21) Appl. No.: 11/904,918

(22) Filed: Sep. 27, 2007

(51) Int. Cl. B66C 3/00

(52) U.S. Cl. 414/785

(57) ABSTRACT

A frame, a system and a method elevates an article are from a floor to a wall. The frame may have an “A” frame for supporting the article. The article may be placed on the frame and secured to the frame. A drive system attached to the frame is used to pull the frame and the article towards the wall. A drive system elevates the front end of the frame and pulls the back end of the frame toward the wall such that the frame and the article are elevated in a vertical position. The frame and the article may be lowered from the vertical position by the drive system.

### BACKGROUND OF THE INVENTION

The present invention generally relates to an apparatus and a system for lifting and storing an article and a method for using the same. More specifically, the lift guides and/or elevates an article onto, for example, a wall. In addition, a frame of the lift may have a first rail and a second rail that support the article. Further, the lift may have a trolley that elevates and/or lowers. A connector may connect the trolley to the frame.

Typically, an article, such as a vehicle, a trailer, equipment or furniture requires storage when not in use. Such articles are often large and require significant amounts of storage space. Generally, the article is stored in a garage. However, if no garage is available, the article is unable to fit in the garage. If the article occupies too much of the garage, the article may be stored at, for example, a storage facility, a shed, an outside area, or the like. Storage at the storage facility, the shed, the outside area and/or the like is typically inconvenient and/or is often costly. Further, if the article is stored outside, the trailer may be, for example, damaged by weather, vandalized or stolen.

Of course, storing the article in the garage requires space within the garage and may prevent storing other items in the garage. Storing articles on a rack suspended from a ceiling to elevate the articles above the floor is known. To use the rack, the article must be hoisted on the rack for storage. Hoisting the article is often difficult and/or cumbersome. Usually more than one person is required to lift the article to the rack for storage.

The known rack is often difficult to use and does not adequately allow the article to be easily and/or quickly placed in or removed from the storage position. In addition, the rack does not permit the user to store the article in a vertical position on, for example, a wall.

A need, therefore, exists for an improved apparatus, system and method for a lift mountable to a wall for lifting and storing an article that may be accomplished by a single person. Further, a need exists for a lift that stores the article in a vertical position. Still further, a need exists for a lift that lifts and stores that article using a mechanical drive system. Additionally, a need exists for an improved apparatus, system and method for automatically lifting and/or storing a article on a wall.

### SUMMARY OF THE INVENTION

The present invention generally relates to an apparatus and system for lifting and storing an article and a method for using the same. More specifically, the lift guides and/or elevates an article onto, for example, a wall. In addition, the lift may have a drive system that has a connector that moves up and down relative to the drive system. A first rail and a second rail may support the article and may have wheels to allow movement.

To this end, in an embodiment of the present invention, an apparatus for lifting an article from a floor to a wall is provided. The floor and the wall are positioned substantially perpendicular relative to each other. The apparatus has a frame that has a front end and a back end wherein the front end is positioned opposite to the back end; a housing that has an interior, a top end and a bottom end wherein the top end is positioned opposite to the bottom end wherein the front end of the frame is positioned adjacent to the housing; a first shaft in the interior of the housing wherein the first extends from the top end of the housing to the bottom end of the housing; and a trolley in the interior of the housing wherein the trolley is connected to the frame and attached to the first shaft and further wherein the trolley moves toward the top end of the housing to elevate the front end of the frame.

In an embodiment, the apparatus has a connector attached to the trolley wherein the connector projects from the trolley and attaches the trolley to the front end of the frame.

In an embodiment, the apparatus has holes in the front end of the frame and the trolley wherein insertion of a pin through the holes connects the front end of the frame to the trolley.

In an embodiment, the apparatus has a wheel attached to the frame.

In an embodiment, the frame is a first rail and a second rail wherein the first rail and the second rail are attached at the front end of the frame.

In an embodiment, the apparatus has a gear connected to the top end of the first shaft wherein rotating the gear rotates the first shaft.

In an embodiment, the apparatus has a motor that rotates the first shaft wherein rotation of the shaft moves the trolley.

In an embodiment, the apparatus has a second shaft connected to the first shaft wherein the first shaft is positioned perpendicular relative to the second shaft.

In an embodiment, the apparatus has threads on the first shaft wherein the trolley is connected to the threads of the first shaft.

In another embodiment of the present invention, a method for lifting an article from a floor to a wall is provided. The floor and the wall are positioned substantially perpendicular relative to each other. The method has the steps of: providing a frame connected to a trolley wherein the trolley is attached to a first shaft and the first shaft is attached to the wall; placing the article on the frame; elevating the trolley relative to the first shaft; and moving the frame with the trolley wherein elevating the trolley elevates a front end of the frame and moves the frame from a first position substantially parallel relative to the floor to a second position substantially perpendicular relative to the floor.

In an embodiment, the method has the step of rotating the shaft wherein rotating the shaft moves the trolley.

In an embodiment, the method has the step of adjusting a width of the frame.

In an embodiment, the method has the step of attaching the article to a pin on the frame wherein the pin projects from the frame.

In an embodiment, the method has the step of attaching a second shaft to the first shaft wherein the second shaft is located in a position substantially perpendicular relative to the first shaft.

In an embodiment, the method has the step of rotating the first shaft using a motor.

In an embodiment, the method has the step of providing a power supply that moves the trolley.

In another embodiment of the present invention, a system for lifting an article from a floor to a wall is provided. The floor and the wall are positioned substantially perpendicular relative to each other. The system has a frame; a housing that has an interior wherein the housing is attached to the wall; a first shaft in the interior of the housing wherein the first shaft; a second shaft connected to the first shaft wherein the first shaft is positioned perpendicular to the second shaft; and a trolley in the interior of the housing wherein the trolley is connected to the frame and attached to the first shaft and further wherein the trolley moves toward a top end of the housing to elevate the front end of the frame.

In an embodiment, the system has a motor connected to the second shaft.

In an embodiment, the system has a power supply that moves the second shaft.

In an embodiment, the system has threads on the first shaft wherein the trolley is connected to the threads of the first shaft.

It is, therefore, an advantage of the present invention to provide a lift for elevating a article and a method and a system for lifting and storing the article.

A further advantage of the present invention is to provide a lift for elevating an article and a method and a system for lifting and storing the article wherein the apparatus is mountable to a wall.

Another advantage of the present invention is to provide a lift for elevating an article and a method and a system for lifting and storing the article wherein the apparatus stores the article.

A further advantage of the present invention is to provide a lift for elevating an article and a method and a system for lifting and storing the article wherein the apparatus has a motor used to elevate the article.

A still further advantage of the present invention is to provide a lift for elevating an article and a method and a system for lifting and storing the article wherein the apparatus is mounted in a garage.

Yet another advantage of the present invention is to provide a lift for elevating an article and a method and a system for lifting and storing the article wherein the apparatus secures the article in a position for storage.

Another advantage of the present invention is to provide a lift for elevating an article and a method and a system for lifting and storing the article wherein the apparatus has a wheel guide.

Yet another advantage of the present invention is to provide a lift for elevating an article and a method and a system for lifting and storing the article wherein the apparatus may be adjusted to fit various sizes of articles.

Another advantage of the present invention is to provide a lift for elevating an article and a method and a system for lifting and storing the article wherein the apparatus may be easily installed.

A still further advantage of the present invention is to provide a lift for elevating an article and a method and a system for lifting and storing the article wherein a connector elevates the article.

Yet another advantage of the present invention is to provide a lift for elevating an article and a method and a system for lifting and storing the article wherein a drive system elevates the article.

Additional features and advantages of the present invention are described in, and will be apparent from, the detailed description of the presently preferred embodiments and from the drawings.

### BRIEF DESCRIPTION OF THE DRAWINGS

FIG. 1 illustrates a perspective view of a frame for elevating an article in an embodiment of the present invention.

FIG. 2 illustrates a perspective view of a frame for elevating an article in an embodiment of the present invention.

FIG. 3 illustrates a perspective view of a frame for elevating an article in an embodiment of the present invention.

FIG. 4 illustrates a perspective view of a drive system in an embodiment of the present invention.

FIG. 5 illustrates a perspective view of a trolley in an embodiment of the present invention.

FIG. 6 illustrates a perspective view of a drive system in an embodiment of the present invention.

FIG. 7 illustrates a perspective view of a drive system in an embodiment of the present invention.

FIG. 8 illustrates a perspective view of a trolley in an embodiment of the present invention.

FIG. 9 illustrates a perspective view of a lift and a drive system in an embodiment of the present invention.

### DETAILED DESCRIPTION OF THE PRESENTLY PREFERRED EMBODIMENTS

The present invention generally relates to a lift and a system for elevating an article and a method for lifting and/or storing the article. More specifically, the lift guides and/or elevates the article upward on a first rail mounted on a wall.

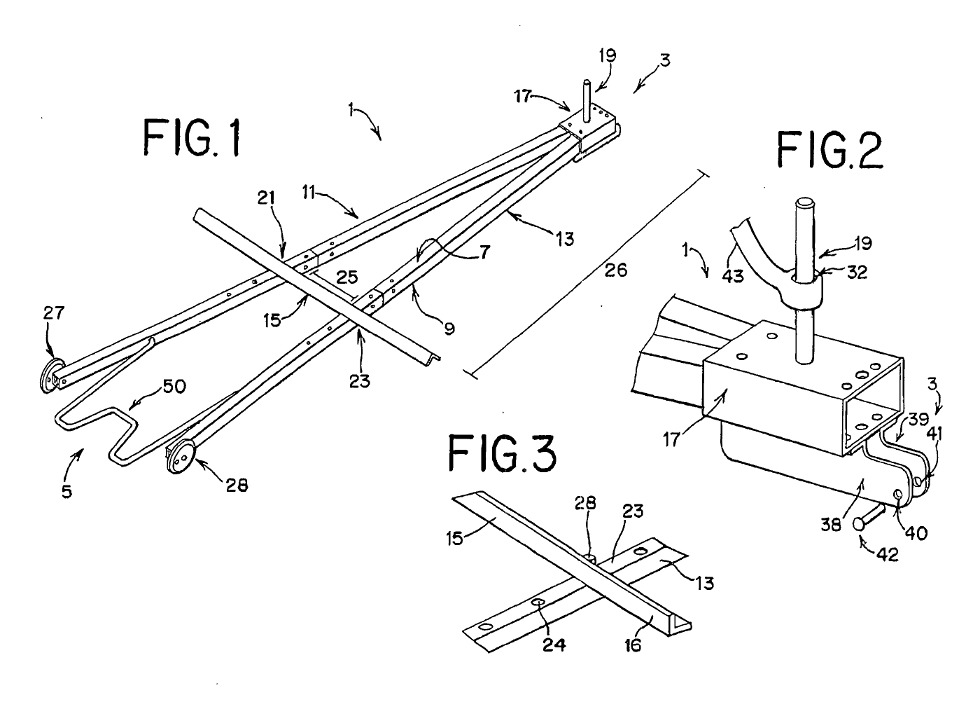

Referring now to the drawings wherein like numerals refer to like parts, FIG. 1 generally illustrates a frame 1 having a first end 3, a second end 5, a top side 7 and a bottom side 9. The frame 1 may be constructed from, for example, metal, wood, fiberglass or the like. Preferably, the frame 1 is shaped like an “A”; however, the frame 1 may be, for example, rectangular or any other shape. The article may be, for example, a vehicle, a trailer, equipment and furniture. The vehicle may be, for example, a bicycle, a snowmobile, a jet ski and/or the like. The equipment may be, for example, a lawnmower, tools, a wheelbarrow and/or the like. The furniture may be, for example, a couch, a bed, a chair and/or the like. The present invention should not be limited to a specific embodiment of the article.

The frame 1 may have a first rail 11, a second rail 13 and a support rail 15. The first rail 11 may be attached to the second rail 13 at the first end 3 of the frame 1. For example, the first rail 11 may be welded to, bolted to, linked by a connector to or integrally formed with the second rail 13. Referring to FIG. 2, a section of the first end 3 of the frame 1 is illustrated. A first connector 17 may be attached to the first rail 11 and/or the second rail 13. A pin 19 may be inserted through the first rail 11, the second rail 13 and the first connector 17. The pin 19 may enable the first rail 11 and the second rail 13 to pivot with respect to each other. Of course, the first rail 11 and the second rail 13 may be attached by any means known to one having ordinary skill in the art.

The article may be connected to the frame 1 by the pin 19 of the connector 17. For example, a tether 43 may attach to the article and to the pin 19 to secure the article to the frame 1. The pin 19 may be inserted in a hole 32 in the tether 43 and may lock the tether 43 onto the pin 19. Any connecting device known in the art may be used to attach the article to the frame 1 and/or the pin 19, such as, for example, a ball-hitch connection or the like.

Referring again to FIG. 1, the support rail 15 may provide stability to the frame 1 by connecting the first rail 11 to the second rail 13, forming an “A” frame. After the support rail 15 is connected to the first rail 11 and the second rail 13, the first rail 11 and the second rail 13 may be locked into place and/or may not pivot with respect to each other.

The support rail 15 may be removably attached to a point 21 on the first rail 11 and/or to a point 23 on the second rail 13. The support rail 15 may be removed and/or may be re-attached to the first rail 11 and/or to the second rail 15. Removal and re-attachment of the support rail 15 may allow the user to adjust a distance 25 between the point 21 of the first rail 11 and the point 23 of the second rail 13. The user may adjust the distance 25 to enable the user to accommodate various sizes of articles.

Referring to FIG. 3, a section of the support rail 15 attached to the second rail 13 is illustrated. The support rail 15 may be detached and/or may be removed from the first rail 11 and the second rail 13 and re-attached to a second point 22 on the first rail 11 and a second point 24 on the second rail 13, respectively. The support rail 15 may be removable from the first rail 11 and the second rail 13 such that the user may adjust a distance 26 between the support rail 15 and the first end 3 of the frame 1. Further, the support rail 15 may be removable from the first rail 11 and the second rail 13 so that the user may also adjust a distance 25 between the point 21 of the first rail 11 and the point 23 of the second rail 13. The frame 1 may be adjusted to accommodate articles of various lengths and/or sizes. The frame 1 may be adjusted by altering the distance 25 between the point 21 of the first rail 11 and the point 23 of the second rail 26. Further, the frame 1 may be adjusted by altering the distance 26 between the support rail 15 and the first end 3 of the frame.

Removal of the support rail 15 may allow the first rail 11 and the second rail 13 to rotate into a substantially parallel position. Rotating the first rail 11 and the second rail 13 to a substantially parallel position may allow for easier handling when storing the frame 1 if the frame 1 is not in use. The support rail 15 may extend above the first rail 11 and/or the second rail 13. The support rail 13 may act as an indicator of where to position the article on the frame 1 prior to elevation and/or storage. The support rail 15 may impede tires of the article from rolling forward and advancing to the first end 3 of the frame 1.

The first rail 11 and/or the second rail 13 may have a first wheel 27 and/or a second wheel 28, respectively. The first wheel 27 and/or the second wheel 28 may be attached to the frame 1 at the second end 5 of the frame 1. The first wheel 27 and/or the second wheel 28 may contact the ground when the frame 1 resides on a floor 29. The first wheel 27 and/or the second wheel 28 may enable the frame 1 to move with minimized resistance.

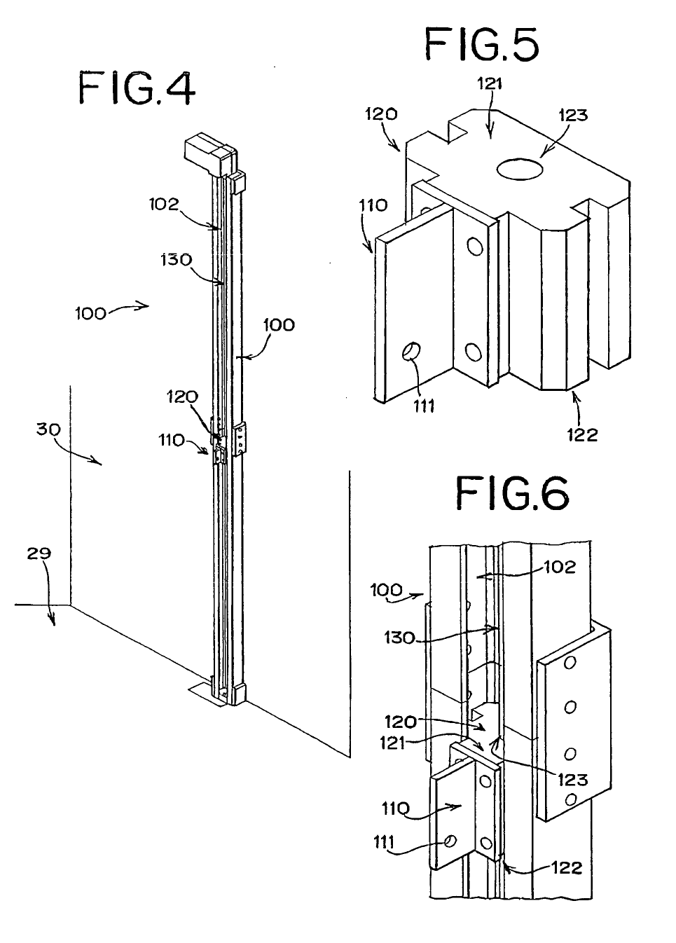

As generally shown in FIG. 4, a drive system 100 may be mounted on, for example, a wall 30. The frame 1 may be connected to the drive system 100 as described below. The drive system 100 may be secured to the wall 30 and may support at least the weight of the frame 1 and the article. The drive system 100 may have a housing 101, and/or the drive system 100 may be attached to the wall 30 by the housing 101. A second connector 110 may be attached to the drive system 100. As generally shown in FIGS. 5 and 6, the second connector 110 may have a hole 111 that extends through the second connector 110. The second connector 110 may be attached to a trolley 120. The second connector 110 may be any connecting means known to one having ordinary skill in the art.

The trolley 120 may have a top surface 121 and a bottom surface 122. A hole 123 in the trolley 120 may extend from the top surface 121 of the trolley 120 to the bottom surface 122 of the trolley 120. The trolley 120 may be attached to a threaded shaft 130 via the hole 123 in the trolley 120. The threaded shaft 130 may insert through the trolley 120 from the top surface 121 of the trolley 120 to the bottom surface 122 of the trolley 120. The housing 101 of the drive system 100 may have an interior 102, and/or the trolley 120 may reside within the interior 102 of the housing 101 of the drive system 100.

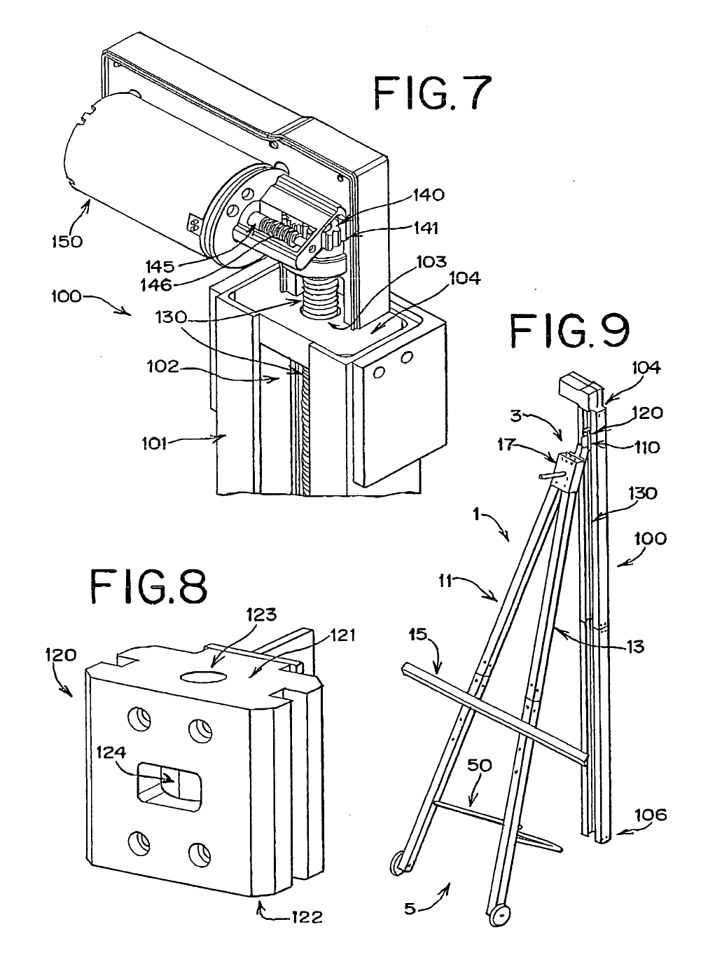

Referring to FIG. 7, the threaded shaft 130 may insert through a hole 103 in the housing 102, and/or the threaded shaft 130 may project from a top end 104 of the housing 102. The threaded shaft 130 may rotate within the interior 102 of the housing 101 of the drive system 100. Rotation of the threaded shaft 130 may move the trolley 120 substantially in a vertical direction. For example, rotation of the threaded shaft 130 in a first direction may elevate the trolley 120 relative to the housing 101 of the drive system 100. Rotation of the threaded shaft 130 in a direction opposite to the first direction may lower the trolley 120 relative to the housing 101 of the drive system 100.

As generally illustrated in FIG. 8, the trolley 120 may be connected to the threaded shaft 130 by a threaded bushing 124. The threaded bushing 124 may reside in the trolley 120 and/or may extend from the top surface 121 of the trolley 120 to the bottom surface 122 of the trolley 120. The threaded bushing 124 may allow the rotation of the threaded shaft 130 in the first direction to elevate the trolley 120. The threaded bushing 124 may allow the rotation of the threaded shaft 130 in the direction opposite to the first direction to lower the trolley 120.

As generally illustrated in FIG. 9, the drive system 100 may have a gear 140 and/or a gear shaft 145. The gear 140 may be attached to the threaded shaft 130. The gear 140 may have teeth 141, and/or the gear shaft 145 may have projections 146. The projections 146 of the gear shaft 145 may be positioned parallel to each other. The gear shaft 145 may connect to the gear 130 via connection of the projections 146 to the teeth 141. The gear shaft 145 may be positioned perpendicular to the threaded shaft 130. The gear shaft 145 may be connected to a motor 150. The motor 150 may move the gear shaft 145 in a direction perpendicular to the threaded shaft 130. The motor 150 may be supplied with electrical power. The electrical power may be supplied from an internal source (not shown) within the drive system 100, for example. Alternatively, the electrical power may be supplied from an external source (not shown), such as, for example, a wall socket. The present invention should not be deemed as limited to the embodiments of a specific electrical power source of the drive system 100.

Movement of the gear shaft 145 in the direction perpendicular to the threaded shaft 130 may move the projections in a direction perpendicular to the threaded shaft 130. Movement of the projections in a direction perpendicular to the threaded shaft 130 may rotate the gear 140 due to the connection of the projections 146 to the teeth 141. Rotation of the gear 140 may rotate the threaded shaft 130 and/or may elevate or lower the trolley 120.

Referring to FIG. 2, the first connector 17 may have a first extension 38 and/or a second extension 39. The first extension 38 and/or the second extension 39 may have a first hole 40 and/or a second hole 41, respectively. A pin 42 may be inserted through the first hole 40 of the first connector 17, the hole 111 of the second connector 110, and/or the second hole 41 of the first connector 17. Thus, the pin 42 may attach the first connector 17 to the second connector 110 and/or may attach the frame 1 to the drive system 100. It should be understood that the first connector 17 may be attached to the second connector 110, and the frame 1 may be attached to the drive system 100 using any means known to one having ordinary skill in the art.

Attachment of the first connector 17 to the second connector 110 may allow the frame 1 to be elevated by the drive system 100 as generally shown in FIG. 9. If rotation of the threaded shaft 130 elevates the trolley 120, the trolley 120 may elevate the second connector 110. If the trolley 120 elevates the second connector 110, the second connector 110 may elevate the first connector 17 and/or the first end 3 of the frame 1. Elevation of the first end 3 of the frame 1 may pull the second end 5 of the frame 1 to a new position that may be closer to the wall 30. If the trolley 120 is elevated to the top end 104 of the housing 101 of the drive mechanism 100, the second end 5 of the frame 1 may be adjacent to a bottom end 106 of the housing 101 of the drive mechanism 100. For example, the frame 1 may be pulled to a vertical position.

If the frame 1 and/or the article reach the vertical position against the wall 30, the drive system 100 may lock the trolley 120 in a fixed position. The fixed position of the trolley 120 may maintain the vertical position of the frame 1 and/or the article. The drive system 100 may release the trolley 120 from the fixed position and/or may lower the trolley 120, and the frame 1 and/or the article may lower toward the ground.

A guide 50 may be attached to the back end 5 of the frame 1. The guide 50 may be connect to the first rail 11 and/or the second rail 13. As generally shown in FIG. 9, the guide 50 may assist the back end 5 of the frame 1 in moving away from the wall 30 if the frame 1 is lowered. As the frame 1 lowers from the vertical position, the guide 50 may prevent and/or decrease resistance from contact of the back end 5 of the frame 1 with the ground.

The article may be connected directly to the drive system 100. The frame 1 may be removed from the drive system 100 and/or the first connector 17 may be disconnected from the second connector 110. The drive system 100 may be provided without the frame 1. Direct attachment of the article to the second connector 110 may allow the article to be elevated by the drive system 100. If rotation of the threaded shaft 130 elevates the trolley 120, the trolley 120 may elevate the article. Elevation of the trolley 120 may pull article to a vertical position.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. An apparatus for lifting an article from a floor to a wall wherein the floor and the wall are positioned substantially perpendicular relative to each other, the apparatus comprising:
a frame that has a front end and a back end wherein the front end is positioned opposite to the back end;
a housing that has an interior, a top end and a bottom end wherein the top end is positioned opposite to the bottom end wherein the front end of the frame is positioned adjacent to the housing;
a first shaft in the interior of the housing wherein the first extends from the top end of the housing to the bottom end of the housing; and
a trolley in the interior of the housing wherein the trolley is connected to the frame and attached to the first shaft and further wherein the trolley moves toward the top end of the housing to elevate the front end of the frame.

2. The apparatus of claim 1 further comprising:
a connector attached to the trolley wherein the connector projects from the trolley and attaches the trolley to the front end of the frame.

3. The apparatus of claim 1 further comprising:
holes in the front end of the frame and the trolley wherein insertion of a pin through the holes connects the front end of the frame to the trolley.

4. The apparatus of claim 1 further comprising:
a wheel attached to the frame.

5. The apparatus of claim 1 wherein the frame is a first rail and a second rail wherein the first rail and the second rail are attached at the front end of the frame.

6. The apparatus of claim 1 further comprising:
a gear connected to the top end of the first shaft wherein rotating the gear rotates the first shaft.

7. The apparatus of claim 1 further comprising:
a motor that rotates the first shaft wherein rotation of the shaft moves the trolley.

8. The apparatus of claim 1 further comprising:
a second shaft connected to the first shaft wherein the first shaft is positioned perpendicular relative to the second shaft.

9. The apparatus of claim 1 further comprising:
threads on the first shaft wherein the trolley is connected to the threads of the first shaft.

10. A method for lifting an article from a floor to a wall wherein the floor and the wall are positioned substantially perpendicular relative to each other, the method comprising the steps of:
providing a frame connected to a trolley wherein the trolley is attached to a first shaft and the first shaft is attached to the wall;
placing the article on the frame;
elevating the trolley relative to the first shaft; and
moving the frame with the trolley wherein elevating the trolley elevates a front end of the frame and moves the frame from a first position substantially parallel relative to the floor to a second position substantially perpendicular relative to the floor.

11. The method of claim 10 further comprising the step of:
rotating the shaft wherein rotating the shaft moves the trolley.

12. The method of claim 10 further comprising the step of:
adjusting a width of the frame.

13. The method of claim 10 further comprising the step of:
attaching the article to a pin on the frame wherein the pin projects from the frame.

14. The method of claim 10 further comprising the step of:
attaching a second shaft to the first shaft wherein the second shaft is located in a position substantially perpendicular relative to the first shaft.

15. The method of claim 10 further comprising the step of:
rotating the first shaft using a motor.

16. The method of claim 10 further comprising the step of:
providing a power supply that moves the trolley.

17. A system for lifting an article from a floor to a wall wherein the floor and the wall are positioned substantially perpendicular relative to each other, the system comprising:
a frame;
a housing that has an interior wherein the housing is attached to the wall;
a first shaft in the interior of the housing wherein the first shaft;
a second shaft connected to the first shaft wherein the first shaft is positioned perpendicular to the second shaft; and
a trolley in the interior of the housing wherein the trolley is connected to the frame and attached to the first shaft and further wherein the trolley moves toward a top end of the housing to elevate the front end of the frame.

18. The system of claim 17 further comprising:
a motor connected to the second shaft.

19. The system of claim 17 further comprising:
a power supply that moves the second shaft.

20. The system of claim 17 further comprising:
threads on the first shaft wherein the trolley is connected to the threads of the first shaft.
